(19) United States
(12) Patent Application Publication
(10) Pub. No.: US 2020/0151817 A1
(43) Pub. Date: May 14, 2020

(54) TOKENIZED COMMODITY FOR MULTIPART TRANSACTIONS VALIDATED BY A PEER-TO-PEER NETWORK OF NODES

(71) Applicant: REFINITIV US ORGANIZATION LLC, New York, NY (US)

(72) Inventor: Samer Mahfouz, Dubai (AE)

(73) Assignee: REFINITIV US ORGANIZATION LLC, New York, NY (US)

(21) Appl. No.: 16/677,060

(22) Filed: Nov. 7, 2019

Related U.S. Application Data
(60) Provisional application No. 62/757,906, filed on Nov. 9, 2018.

(51) Int. Cl. G06Q 40/04; H04L 29/08; G06Q 20/22; G06Q 20/38; G06Q 20/36; G06F 16/27

(52) U.S. Cl. CPC G06Q 40/04; H04L 67/104; G06Q 20/223; G06Q 2220/00; G06Q 20/38215; G06Q 20/3674; G06F 16/27; G06Q 20/389

(57) ABSTRACT

Computer-readable media, systems and methods may improve an ability to validate a multipart transaction involving multiple parties and sub-transactions and securely store and access multipart transaction data through a peer-to-peer computer network and a distributed ledger. A multipart transaction, such as a Murabaha transaction, may refer to a transaction having multiple parts involving multiple parties in connection with an agreement between two or more of the parties in which a commodity sale or other vehicle is created based on the agreement. The commodity may be tokenized for transfer in the multipart transaction. Validation of digitally signed data relating to the sub-transactions may provide secure authentication of the sub-transactions and atomic transfers of the tokenized commodity between relevant parties of sub-transactions in connection with the agreement. Storage of the validated sub-transactions and transfers on the distributed ledger may provide secure, immutable, and transparent proof of the validated sub-transactions and transfers.

### RELATED APPLICATIONS

This application claims priority to U.S. Provisional Patent Application No. 62/757,906, filed on Nov. 9, 2018, the content of which is incorporated by reference in its entirety herein.

### BACKGROUND

Different parties may have diverse systems for validating, storing and accessing agreements with other parties. As such, these systems may be unable to provide an efficient technology platform to provide end-to-end validation and verification of transactions, particularly multiple transactions involving multiple parties.

### SUMMARY

The disclosure relates to computer-readable media, systems and methods that improve an ability to validate a multipart transaction involving multiple parties and sub-transactions and securely store and access multipart transaction data. For example, a peer-to-peer computer network, such as a blockchain network, and a distributed ledger may be used to validate, store, and access, multipart transaction data. A multipart transaction may refer to a transaction having multiple parts involving multiple parties in connection with an agreement between two or more of the parties, and the transfer of a commodity between the two or more parties (and intermediary parties such as brokers) to create a commodity sale. The agreement may relate to a transaction between the two or more parties and may be unrelated to the commodity sale but whose terms are used to specify the commodity sale. For example, the commodity sale may include a sale price and a profit based on terms of the original agreement. In a particular example, a multipart transaction may include an agreement between a customer and a bank, and multiple sub-transactions between the customer, the bank, and/or intermediary parties, such as commodity brokers, that transfer the commodity based on the terms of the agreement that is unrelated to the commodity sale. Thus, the sub-transactions may involve the transfer of the commodity between various parties.

In a particular example, the multipart transaction may be a Murabaha transaction in which a commodity is transferred between a first party such as a customer and a second party such as a bank to back an agreement in which the second party provides a first value (such as a loan or other funds) to the first party in exchange for repayment of the first value plus a second value (such as an interest rate). Instead of charging a prohibited interest rate, a commodity transfer may be created in which the sale price may be based on the first value and the profit may be based on the second value. The foregoing may avoid a prohibition of charging interest for a loan in Sharia law, for example.

Regardless of the specific type of multipart transaction that is conducted, because each party may include diverse systems for storing and accessing sub-transaction data, these systems may be unable to provide an efficient technology platform to provide end-to-end validation and verification of the sub-transactions of the multipart transaction. In various examples, the disclosure relates to improved systems that automatically validate the sub-transactions (which may be in order as they should occur), tokenize the commodity to generate a commodity token that is transferred between the different parties, and record the validated sub-transactions, including commodity token transfers, on a distributed ledger accessible to the parties.

For example, each sub-transaction of the multipart transaction may be validated at a peer-to-peer network of nodes. Each node may be programmed by a smart contract that includes customized instructions that are automatically executed by the node. For example, the node may be programmed to validate and record the sub-transactions in data structures consistent with the distributed ledger. In some examples, the peer-to-peer network of nodes may include a blockchain network that implements distributed ledger technology (“DLT”).

Each party may be provided with a public key and a private key to interface with the peer-to-peer network of nodes to submit verifications of the party's participation in a given sub-transaction. For example, a customer and a bank may each submit data indicating participation in the agreement. The data may be digitally signed with a submitting party's private key, which may be validated by the peer-to-peer network of nodes using the party's public key, which identifies a given party.

Upon validation, the peer-to-peer network of nodes may automatically execute instructions of the smart contract, including writing the validations to the distributed ledger. The smart contract may program the peer-to-peer network of nodes to expect the digitally signed data from each party and to write the validations atomically—that is, when only both validations have been performed. The sub-transactions may be similarly validated and written to the distributed ledger, forming an end-to-end validation of various parts of the multipart transaction.

In various examples, a computer system may tokenize the commodity and facilitate the transfer of the tokens using DLT. A party such as a customer, through a blockchain interface (such as blockchain wallet) may provide a money payment promise token that tokenizes a promise to purchase the commodity from the bank at a price that is equivalent to the loan amount plus a profit. Similarly, another party, such as a bank, may provide a second money payment promise token that tokenizes a promise to provide a loan amount from the sale of the commodity (after the initial transfer from the bank to the customer) from the second party to the first party.

In some examples, the computer system may provide the instructions for the smart contract and/or other instructions for execution on one or more of the peer-to-peer network of nodes. In this sense, the computer system may include computer readable media for storing the instructions for the smart contract and/or other instructions for execution at the peer-to-peer network of nodes.

The foregoing and other features of the disclosure may be implemented according to various architectures to interface with diverse trading systems to create commodity transfers as described herein. However, it should be understood that other approved vehicles may be used instead of or in addition to a commodity. For example, an approved vehicle may include, without limitation, a letter of credit, an Islamic monetary certificate, Islamic bonds (sukuk), a term deposit, and Islamic insurance. Any one of foregoing may accordingly be tokenized herein. Thus, a vehicle may be tokenized as described herein with respect to a commodity. As such, in particular examples, various trading systems may come into compliance with Sharia or other requirements that may benefit from the use of the multipart transaction computer readable media, systems, and methods for commodities or other approved vehicles described herein.

For example, the computer system may include an adapter that subscribes to or otherwise receives notifications of agreements such as trades from an electronic trading system, such as an electronic trading venue or other electronic market. The adapter may receive agreement information, including an identification of the parties and terms of the agreement. The adapter may fill in Islamic-specific or other data, such as terms of the commerce sale based on the terms of the agreement. The adapter may provide the Islamic-specific or other data to the parties involved in the agreement and to a blockchain adapter, which may be part of the computer system or a standalone component. The blockchain adapter may program the smart contract with the agreement information and/or the Islamic-specific or other data, and provide the smart contract to the peer-to-peer network of nodes for execution thereon. Subsequently, the various parties, including commodity brokers, may execute sub-transactions (which may involve a respective commodity sale or transfer, evidenced by transfer of the commerce token) relating to the agreement, and submit digitally signed data indicating completion of the sub-transaction. The smart contract may validate the digitally signed data and may write the sub-transaction information to the distributed ledger.

### BRIEF DESCRIPTION OF THE DRAWINGS

Features of the present disclosure may be illustrated by way of example and not limited in the following Figure(s), in which like numerals indicate like elements, in which:

FIG. 1 illustrates a block diagram of a system for managing multipart transactions on a blockchain backed by tokenized commodities, according to an example.

FIG. 2 illustrates a flow diagram of an example data flow for multipart transactions on a blockchain, according to an example.

FIG. 3 illustrates a block diagram of managing multipart transactions of multiple parties on a blockchain network backed by tokenized commodities, according to an example.

FIG. 4 illustrates a data flow diagram for an example architecture of implementing multipart transactions of multiple parties on a blockchain network backed by tokenized commodities, according to an example.

FIG. 5 illustrates a flow diagram of an example method for registering parties for multipart transactions backed by tokenized commodities on a peer-to-peer network, according to an example.

FIG. 6 illustrates a flow diagram of an example method for facilitating multipart transactions backed by tokenized commodities on a blockchain, according to an example.

FIG. 7 illustrates a flow diagram of an example method for processing sub-transactions of a multipart transaction backed by tokenized commodities in a blockchain network, according to an example.

### DETAILED DESCRIPTION

The disclosure relates to tokenization of commodities on a blockchain to facilitate immutable proof of multipart transactions through a blockchain network. A multipart transaction may involve multiple parties and distinct sub-transactions, which may be mediated by self-executing smart contracts and immutably stored on a distributed ledger. Each sub-transaction in the multipart transaction may involve the transfer of a commodity through a chain of parties in which each transfer represents part of the multipart transaction.

Each of the parties in the multipart transaction may use respective computer and storage systems, rendering an ability to track, store, and manage the multipart transaction in a secure, transparent and efficient manner difficult.

The system may improve upon such computer and storage systems by implementing customized tokenization of commodities and different types of tokens for mediating the multipart transactions on a blockchain network through smart contracts. A smart contract may include automatically executed code (instructions that program a hardware processor in the blockchain network) that enforces agreed-upon terms for multipart transactions involving multiple parties.

The system may facilitate the sub-transaction in the multipart transaction based on the use of various types of tokens of the blockchain network. For instance, the system may use a loan token and a commodity token. The loan token may tokenize a promise to pay back a loan and the commodity token may tokenize a commodity. The token may be transferred from one party to another party, with double spending prevented by the blockchain network. By transferring various tokens and recording such transfers relating to the sub-transaction on the distributed ledger, an immutable record of the multipart transaction may be stored.

The distributed ledger may therefore provide immutable, distributed, and secure proof of the sub-transaction in the multipart transactions, such that ownership of a commodity involved in the multipart transaction may be verified for any point in time based on tokenization of the commodity. As such, the distributed ledger may provide the basis to verify each transaction in the multipart transaction and may facilitate compliance with the requirements of Murabaha transactions, Wakala transactions, and other transactions backed by a tokenized commodity.

Examples of a multipart transaction disclosed herein may refer to a Murabaha transaction for illustrative purposes. However, other types of multipart transactions for which a tokenized commodity may benefit from the disclosure as well. In a Murabaha transaction, a customer may enter into a loan agreement with a bank for a certain loan amount in exchange for a promise to repay the loan amount plus interest. However, in jurisdictions where interest on a money loan is prohibited, a commodity transfer between the customer and the bank may be created based on the loan amount and the interest. Such commodity transfer may include a sale price of the commodity based on the loan amount and a profit margin for the bank based on the amount of interest. Thus, instead of providing a loan from the bank to the customer, the bank may instead provide a transfer of the commodity based on an agreement upon profit margin for the bank in lieu of an impermissible interest charge.

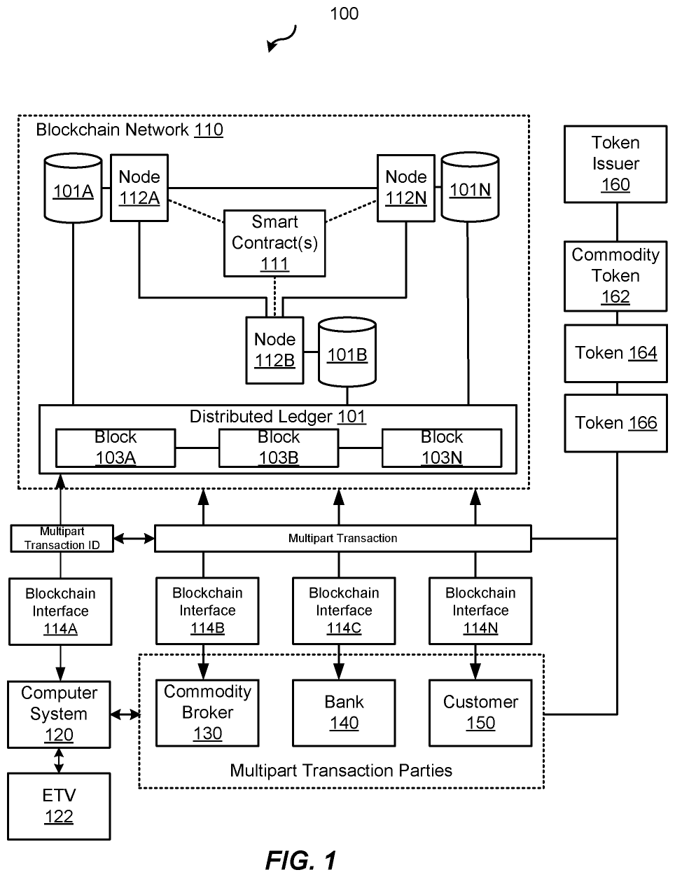

Having described a high-level overview of the disclosure, attention will now turn to a description of the system 100 with reference to FIG. 1, which illustrates a block diagram of a system 100 for managing multipart transactions on a blockchain backed by tokenized commodities, according to an example. System 100 may include a blockchain network 110, blockchain interfaces 114 (illustrated as blockchain interfaces 114A-N), a computer system 120, the computer systems of various parties (illustrated as a commodity broker 130—also referred to as “broker 130”, bank 140, customer 150, and token issuer 160), and/or other components. It should be noted that the bank 140 and customer 150 may be other types of parties as well.

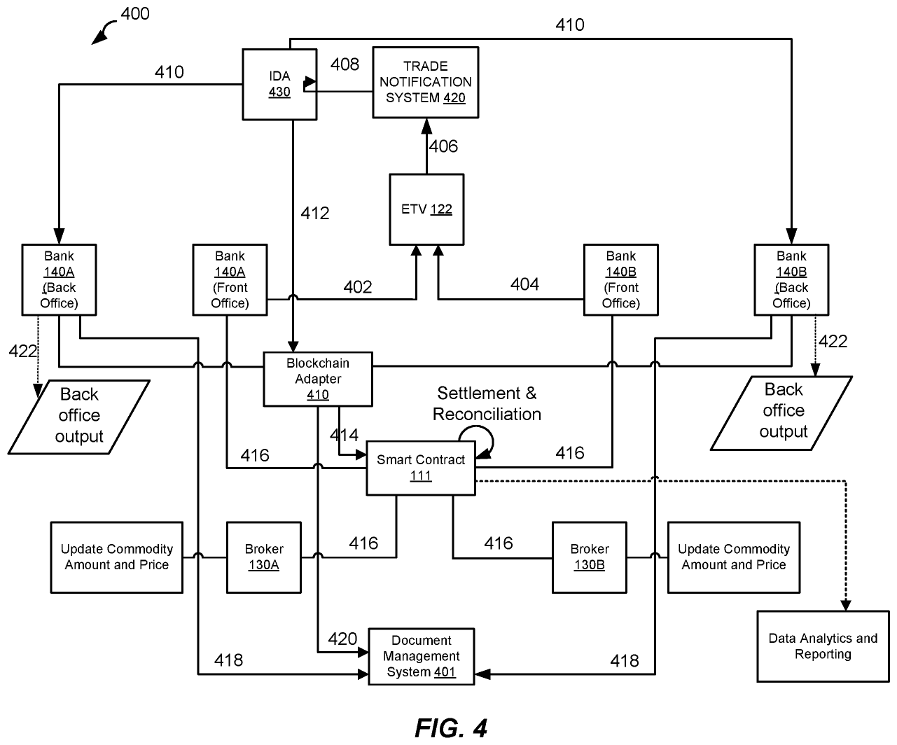

The computer system 120 may interface with the blockchain network 110 to provide multipart transaction information. For example, the computer system 120 may include various adapters (illustrated in FIG. 4 as IDA 430 and blockchain adapter 410). In some examples, the computer system 120 may include computer readable media that stores the instructions of the smart contract 111 and/or other instructions transmitted to and executed at the nodes 112.

An Electronic Trading Venue (“ETV”) 122 may provide a trading platform through which parties may execute transactions, such as money market (“MM”) or other types of transactions. The parties may include banks 140 (or other lender or source of funds) and customers 150 that may enter into MM transactions, which may include short term notes. Agreements on the ETV 122 may be backed by the tokenized commodity and immutably recorded via the blockchain network 110 disclosed herein, such as to be compliant with Sharia law or other authority or mandate. For example, commodity brokers 130 may broker a commodity that is tokenized to back the agreement between the customer 150 (which may be an individual, another bank, or other entity) and the bank 140. The commodity may include any real commodity such as a raw material (aluminum will be used in various examples) or a manufactured article. A token issuer 160 may tokenize the commodity to generate a commodity token 162 (also referred to as “token 162”), which may be used to back the multipart transaction described herein. The token issuer 160 may be part of the computer system 120 or may be a standalone system.

As used herein, the term “tokenize” may refer to representing a commodity as data in a way that may be immutably recorded on the distributed ledger 101. The data may quantify the commodity (such as a count, weight or amount), identify the commodity, identify a source of the commodity, and/or otherwise describe the commodity. In some examples, the token issuer 160 (i.e., a commodity issuer) may verify a quantity of the commodity available for tokenization, such as through verified inventory or may otherwise allocate a quantity of the commodity through commodity markets (not illustrated). As such, a commodity token 162 may represent a quantity of a commodity that may not be double spent. The commodity token 162 may be transferred between parties through their respective blockchain interfaces 114, as will be described herein.

The blockchain network 110 may include a peer-to-peer network of nodes 112 (illustrated as nodes 112A-N). Each node 112 may employ a DLT, in which a protocol for validating data and incorporating the validated data into a distributed ledger 101. In some examples, each node 112 may include a local copy (101A-N) of some or all of a distributed ledger 101. Changes made to the distributed ledger 101 by a node 112 may be shared to other nodes 112, such as a in a peer-to-peer fashion. The distributed ledger 101 may include a series of blocks of data 103A-N that that are chained together. For example, each block 103 may be identified by a hash. Each block 103 may include a reference to a previous block's hash. In this manner, the blocks of data may be chained together. An example of a DLT is described in the well-known white paper “Bitcoin: A Peer-to-Peer Electronic Cash System,” by Satoshi Nakamoto (“http [colon] bitcoin [dot] org”), the contents of which are incorporated by reference in its entirety herein. Other DLTs may be used as well, such as the Ethereum platform, described in the white paper, “Ethereum Specification” (“https [colon] [double forward slash] github [dot] com [forward slash] Ethereum [forward slash] wiki [forward slash] wiki [forward slash] White-Paper”), CORDA blockchain platform (“https [colon] [double forward slash] www [dot] corda [dot] net”), the contents of each of which are incorporated by reference in their entireties herein.

When a first party executes a transaction (from among a plurality of transactions) of a multipart transaction with a second party, the first party may submit a blockchain transaction, which may be digitally signed, that indicates the execution of the sub-transaction by the first party. Likewise, the second party may submit a blockchain transaction, which may be digitally signed, that indicates the execution of the sub-transaction by the second party. It should be noted that a “blockchain transaction” is a term associated with entry into a distributed ledger 101 of the DLT platform, as distinguished from a “transaction” entered into by different parties that may be recorded on the distributed ledger 101 through the submission of a blockchain transaction.

Each party may submit a blockchain transaction through a respective blockchain interface 114 (illustrated as blockchain interface 114A-N) for validation and storage on the distributed ledger 101. In some examples, each blockchain interface 114A-N may be configured as an electronic wallet provided (from a wallet provider of a DLT platform (not illustrated)) to each party. Each wallet may be assigned with a public key and a private key. The private key may be held in secret by each wallet while the public key may publicly available to identify the corresponding wallet. Thus, each party may have a private key stored in the party's electronic wallet or other secure location. In these examples, data digitally signed with a party's private key may be verified by using the publicly available public key. Thus, a blockchain transaction that is digitally signed by a party using the party's private key may be publicly verified using the corresponding public key.

The public key may be used to identify tokens (such as tokens 162, 164, 166) associated with the wallet's public key recorded on the distributed ledger 101. A given wallet may “hold” the tokens based on an association of the tokens with the wallet's public key recorded on the distributed ledger 101 or based on previously assigned transaction that pre-allocate tokens for the wallet.

In some examples, all or portion of a token value may be transferred between wallets by generating a blockchain transaction that identifies a recipient's public key and a transfer amount. As such, transfer of a commodity token 162 may be immutably stored on the distributed ledger 101, preventing a double-spend problem, and complying with the requirements for a Muhabara trade.

When a blockchain transaction is broadcast to the blockchain network 110, the blockchain transaction may be stored in a blockchain transactions store accessible to the nodes. The sending party may digitally sign the blockchain transaction with the sender's private key. Transactions may be relayed to various nodes 112 in the blockchain network 110 in a peer-to-peer manner. The blockchain network 110 may verify the blockchain transaction by using the sender's public key to verify that the sender actually signed the blockchain transaction, that the sender has sufficient tokens, and the tokens haven't been double-spent. Other consensus validation processing may be performed as well.

Once validated, the blockchain transaction may be accepted by consensus and written to a block 103, which is added to the distributed ledger 101. The blockchain transaction may be grouped with other blockchain transactions into a single block 103. For Proof-of-Work implementations, the blockchain transaction(s) may be hashed together with a nonce and the hash of the previous block 103 until a hash value below a threshold value is found (as set by the blockchain network 110). Various nodes 112 may compete to add blocks 132 to the distributed ledger 101. As a reward for doing so, operators of nodes 112 may be provided with a reward in the form of a transaction fee. For Proof-of-Stake implementations, the blockchain transaction(s) may be hashed together by nodes 112 that hold a certain number or value of tokens (thereby proving their stake in the system).

A node 112 may process one or more of the blockchain transactions in the transactions store for entry into the distributed ledger 101. Such processing may be based on automatically executing smart contracts 111. Depending on the type of DLT used by the blockchain network 110, the smart contracts 111 may be instantiated within a blockchain virtual machine generated by the node 112 or may be stored on the distributed ledger 101 or other storage for execution by the node 112. In either case, the node 112 may verify the blockchain transactions to ensure that they were digitally signed by the appropriate parties, and ensure other requirements agreed upon by the parties have been met. Once the node processes and validates the blockchain transaction(s), then the node 112 may write the blockchain transaction(s) and their corresponding data payloads, which may include information from the sub-transactions of the multipart transaction entered into by the parties, to the distributed ledger 101, which may then be propagated to the other nodes 112 in a peer-to-peer manner.

Although not illustrated, the computer system 120, and each node 112 may include a processor and a memory that stores instructions that program the processor to perform various operations of the node described herein. In some examples, the processor of the node 112 may include a semiconductor-based microprocessor, a central processing unit (CPU), an application specific integrated circuit (ASIC), a field-programmable gate array (FPGA), and/or other suitable hardware device. The memory may have stored thereon machine-readable instructions (which may also be termed computer readable instructions) that program the node to execute various functions. The memory may be an electronic, magnetic, optical, or other physical storage device that includes or stores executable instructions. The memory may be, for example, Random Access memory (RAM), an Electrically Erasable Programmable Read-Only Memory (EEPROM), a storage device, an optical disc, and the like. The memory may be a non-transitory machine-readable storage medium, where the term “non-transitory” does not encompass transitory propagating signals. The memory may store the local copy of the distributed ledger 101 for the node 112, or the distributed ledger 101 may be stored in a location that is otherwise accessible to the node 112. It should be noted that the memory may store instructions that when executed on one or more nodes 112 programs the one or more nodes 112 to perform one or more of the operations disclosed herein throughout. As such, the memory may store instructions that programs the nodes 112 of the blockchain network 110. In some examples, the memory may store instructions that program various other components to perform operations disclosed herein throughout as well, such as the commodity broker, bank 140, customer 150, IDA 430, and/or other components disclosed herein.

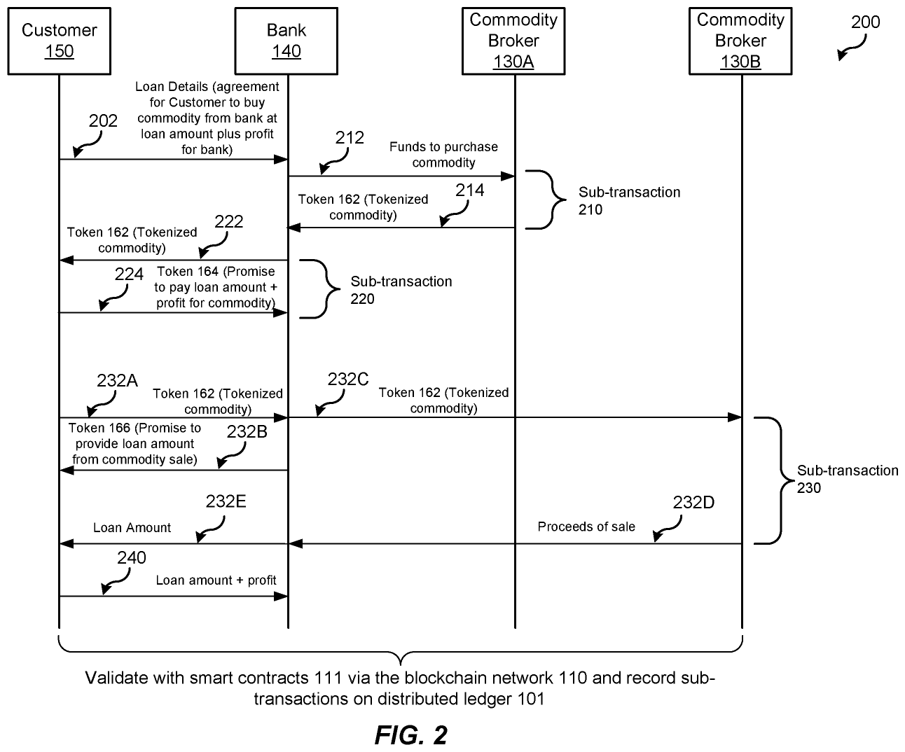

Attention will now turn to an example of executing and recording a multipart transaction with reference to FIG. 2, which illustrates a flow diagram of an example data flow 200 for multipart transactions on a blockchain. It should be noted that in this example context, data flows at 202-240 may represent a process of providing, from the bank 140 to the customer 150, funds for a loan or other funds in a manner that is compliant with a Murabaha transaction. The data flow at 240 may represent a repayment of the loan by the customer 150. Other types of multipart transactions, other than for a loan, may be similarly made based on the disclosure herein.

At 202, the customer 150 may negotiate with the bank 140 details of an agreement that is part of a multipart transaction. The details may include a loan amount, a profit rate, a start end, an end date (such as loan maturity date), account details (such as financial account information or wallet addresses/public keys), commodity to be used to back the multipart transaction, quantity of the commodity, buy price of the commodity used to back the agreement, and/or other information. In some examples, instead of charging interest, the bank 140 may sell the commodity, such as commodity, to the customer 150 at the loan amount plus profit rate to comply with the requirements of a Muhabara deal. The commodity may be tokenized to generate commodity token 162 for transferring ownership of the agreed upon commodity and quantity of the commodity. The agreement may constitute a sub-transaction of the multipart transaction and may therefore be validated and recorded to the distributed ledger 101 through a blockchain interface 114.

As part of the process of backing the agreement made at 202, a sub-transaction 210 including operations at 212 and 214 between the bank 140 and a commodity broker 130A may be processed. For example, at 212, the bank 140 may provide funds to the commodity broker 130A to purchase the commodity. A legal contract for the purchase may be populated using based on the details from 202. The bank 140 and the commodity broker 130A may review and approve the terms and confirm the purchase by each submitting a digitally signed blockchain transaction for verification. The purchase may be processed by the smart contract 111 only when both the bank 140 and the commodity broker 130A submit their respective signed blockchain transactions and the signed blockchain transactions are verified as described herein (such as through use of private key/public key verification). The smart contract 111 may be described herein throughout as performing an operation when, in fact, the smart contract 111 programs a processor of a hardware device, such as a node 112, to perform the operation.

If the transfer is validated (by submission of a confirmation as previously described) by each of the bank 140 and commodity broker 130A), the smart contract 111 may mediate the trade so that funds are transferred from the bank 140 to the broker 130A. In some examples, such funds transfer may occur automatically through cryptocurrency or other blockchain-enabled payment such as via a currency token. In other examples, such payments may be made through third party payment networks (not illustrated). Once the payments have been made (which may be mediated by the smart contract 111 through cryptocurrency or third-party payment networks), at 214, the smart contract 111 may transfer (or cause to be transferred) the commodity token(s) 162 corresponding to the quantity of commodity sold may be transferred from the commodity broker 130A to the bank 140 (such as through their respective wallets.

As another part of the process of backing the agreement made at 202, a sub-transaction 220 including operations at 222 and 224 between the bank 140 and the customer 150 may be processed. For example, at 222, the bank 140 may sell the commodity (purchased from the commodity broker 130A) to the customer 150 on a deferred payment basis. For example, the deferred payments from the customer 150 to the bank 140 may represent payments for the commodity.

At 224, to memorialize this sub-transaction, the money payment promise token 164 (also referred to as “token 164”) may be transferred from the customer 150 (such as from a wallet of the customer) to the bank 140 (such as to a wallet of the bank) and the commodity token 162 may be transferred from the bank 140 to the customer 150 (via respective wallets). The token 164 may be a tokenized promise to purchase the commodity from the bank 140 at a price that is equivalent to the loan amount plus a profit. Such transfer may occur atomically, be mediated by the smart contract 111 and may only occur when the digitally signed blockchain transactions for this sub-transaction are verified. The term “atomically”, “atomic”, and similar terminology may refer to performing an operation with at least one other operation such that either both are executed to completion or none of them are executed to completion. Such atomicity may occur simultaneously or in succession so long as the two or more operations are all executed successfully or none of them are. Thus, if one of the two or more operations fail, the other(s) will not be executed or will be rolled back if already executed. In some examples, a legal contract and/or a hash of the legal contract for the commodity sale from the bank 140 to the customer 150 may be included as a blockchain transaction payload for entry into the distributed ledger 101. For example, a transaction may be atomically controlled to track approvals of the transaction from relevant parties, maintain an evidence trail of what was transacted and for what consideration, and provides documentary proof of the transaction.

As another part of the process of backing the agreement made at 202, a sub-transaction 230 including operations at 232A-E between the bank 140, the customer 150, and the commodity broker 130B may be processed. For example, at 232A, the customer 150 may assign the bank 140 to act as an agent of the customer to sell the commodity and transfer the token 162 back to the bank subject to the sale and provision of the loan amount from the proceeds of the sale. At 232B, the bank 140 may transfer a token 164 to the customer 150. The token 164 may be a tokenized promise for the bank to provide the loan amount from the proceeds of the sale. Again, the assignment and transfer may occur atomically and only when both parties have verified blockchain transactions. In some examples, a legal contract and/or a hash of the legal contract for the commodity sale by the bank 140 on behalf of the customer 150 may be included as a blockchain transaction payload for entry into the distributed ledger 101.

At 232C, the bank 140 may sell the commodity to the commodity broker 130B (or to one or more other commodity brokers 130). Accordingly, the token 162 may be transferred from the bank 140 to the commodity broker 130B. Again, the assignment and transfer may occur atomically and only when both parties have verified blockchain transactions. In some examples, a legal contract and/or a hash of the legal contract for the commodity sale by the bank 140 on behalf of the customer 150 may be included as a blockchain transaction payload for entry into the distributed ledger 101.

At 232D, funds for the sale may be transferred from the commodity broker 130B to the bank 140, whether automatically and/or through third parties. Again, such transfers may occur atomically and only when both parties have verified blockchain transactions. In some examples, a legal contract and/or a hash of the legal contract for the commodity sale from the bank 140 to the commodity broker 130B may be included as a blockchain transaction payload for entry into the distributed ledger 101. At 232E, the bank 140 may provide the loan amount (from the proceeds of the sale at 212D) to the customer 150. Such provision may be automatically and/or through third-party payment system described herein.

At 240, the customer may repay the loan amount plus profit to the bank 140 according to the loan details, at which point the token 164 may be destroyed or otherwise transferred back to the customer 150. Various techniques for token destruction on a DLT may be used to destroy such token 164, and such destruction may be subject to verification and agreement by the bank 140 that the loan amount plus profit has been received at the bank 140. Alternatively, for automatically paid loan amounts plus profit, the smart contract 111 may automatically determine that the loan amount plus profit has been paid and may initiate the destruction or transfer of token 164.

Each of the foregoing actions may represent a sub-transaction in a multipart transaction. Some or all of the sub-transactions may be facilitated through the use and transfer of tokens. Each of the sub-transactions may also be processed via the blockchain interface 114 of each party, and stored at the distributed ledger 101. Furthermore, each of the sub-transactions and transfers described herein may be associated with signed contracts uploaded for validation and entry into the distributed ledger 101 as immutable proof of such sub-transaction. In some examples, a hash of the contract and/or the actual contract document may be stored on the distributed ledger 101. In some examples, a legal contract document that is electronically or physically signed may be attached to the sub-transaction representing the commodity purchase by the bank 140 from the commodity broker 130A. In these examples, the legal contract document may be included as part of the blockchain transaction payload. In some of these examples, a hash of the signed legal document may be uploaded as part of the blockchain transaction payload. The hash may be a deterministically generated hash (such as a SHA-256 hash) that generates a generally unique output (the hash) base on unique input in a deterministic way. Thus, a document that has been altered from an original copy will generally result in a different hash than a hash generated for the original. In some examples, a copy of the legal contract may be stored at a peer-to-peer file sharing network, such as an InterPlanetary File System (“IPFS”). In these examples, a file link to the legal contract at the peer-to-peer file sharing network may be stored as part of a transaction on the blockchain.

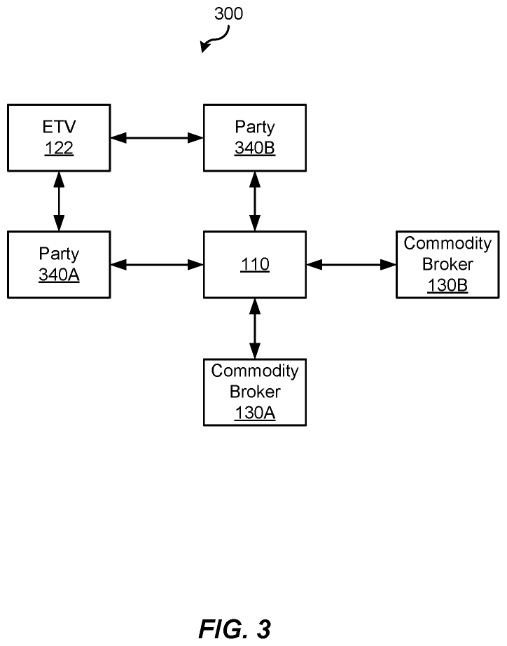

FIG. 3 illustrates a block diagram 300 of managing multipart transactions of multiple parties on a blockchain network 110 backed by tokenized commodities, according to an example. In the illustrated example, two parties 340A and 340B may make an agreement via ETV 122. Various types of trades such as a money market instrument or other cash flow from one party to another with interest or other financial instrument may be traded. The parties 340A and 340B may correspond to banks that borrow from one another or other parties.

Once a legal contract (as opposed to the smart contract 111 illustrated in FIG. 1) with details of the agreement are agreed upon, the parties 340A and 340B may back the agreement via a tokenized commodity (such as token 162 that tokenizes commodity brokered by commodity brokers 130A and 130B), validated and stored via the blockchain network 110. The details of the agreement of the multipart transaction backed by the tokenized commodity may be similar to the example at FIG. 2, in which case the party 340A may acts as a bank and the party 340B may act as a customer. Accordingly, instruments traded and/or negotiated on third party financial platforms, such as ETV 122, may use the disclosure herein to back up the agreements relating to the instruments using a tokenized commodity. As such, the agreements on the third-party financial platforms may become Sharia compliant through the use of a Murabaha style transaction using blockchain network and related components described herein.

FIG. 4 illustrates a data flow diagram for an example architecture 400 of implementing multipart transactions of multiple parties on a blockchain network 110 backed by tokenized commodities, according to an example. An Islamic Dealing Adapter (IDA) 430 may provide Islamic related fields for transactions conducted on an ETV 122. The Islamic related fields may back-fill transactions on the ETV 122 so that the agreement on the ETV may be compliant with Sharia law. The blockchain adapter 410 may facilitate multipart transactions on the blockchain network 110 for validation and immutable tracking of the sub-transactions that may be necessary for such compliance. A document management system 401 may manage legal documents such as legal contracts that are executed between any given two or more parties, such as between a bank 140A and a bank 140B; and between a bank 140 and a commodity broker 130 (illustrated in FIG. 4 as “broker 130” for convenience).

At 402 and 404, banks 140A and 140B may execute a trade on the ETV 122. The trade may relate to a MM instrument, a foreign exchange (FOREX) trade, and/or other type of trade. At 406, the ETV 122 may provide the trade notification system 420 with an indication of the trade. At 408, a notification of the trade may be provided to the IDA 430. At 410, the IDA 430 may fill in the Islamic fields and provide the back offices of the banks 140A and 140B with the trade information with Islamic fields, which may be specific to a Murabaha or other type of transaction backed by the features of the disclosure herein.

At 412, the IDA may pass the agreement with the Islamic fields to the blockchain adapter 410. At 414, the blockchain adapter 410 may set various values of the smart contract 111 for the trade. Such values may be based on the values of the trade, such as interest rate, amount, and/or other values of the trade. At 416, the smart contract 111 may mediate settlement and reconciliation of the trade through multipart transaction processing (such as transfer of the token 162 through party wallets), an example of which is described with respect to FIG. 2. It should be noted that the front offices of each of the banks 140A and 140B and each of the brokers 130A and 130B may participate in such processing through submission of blockchain transactions as previously described.

At 418, the front offices of the banks 140A and 140B may negotiate legal contracts relating to the trade and sub-transactions and execute and store via the document management system 401. At 420, the blockchain adapter 410 may provide proof information (such as via block identifiers, hashes, blockchain transaction payloads, etc., from the distributed ledger 101) of the agreement execution to the document management system 401, which may store the proof information in connection with the legal contracts. In some examples, at 422, each of the back offices of the banks 140A and 140B may generate back office output based on the trade notification and Islamic fields. In some examples, each of the back offices of the banks 140A and 140B may use the blockchain adapter 410 to access multipart transaction data stored on the distributed ledger 101.

It should be noted that the agreement from the ETV 122 may be identified by a multipart transaction identifier, which may be stored in association with the various data produced in the data flow illustrated in FIG. 4. In this manner, the proof information and other information from the distributed ledger 101 may be linked back to a given transaction made on the ETV 122 so that immutable proof of the tokenized commodity that backed the agreement may be recalled for verification purposes. As such, the data flow and architecture illustrated in FIG. 4 (and the various components and operations disclosed herein) may facilitate Sharia compliant trades made on the ETV 122 and other financial transactions.

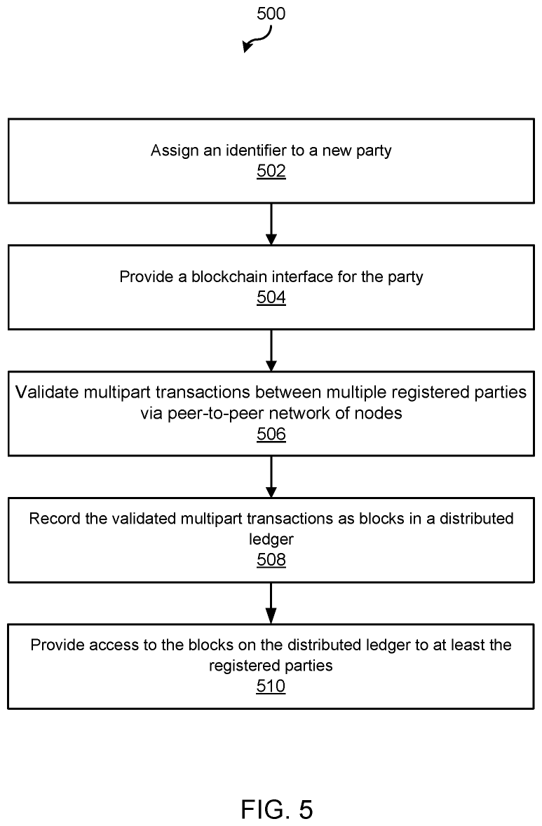

FIG. 5 illustrates a flow diagram of an example method 500 for registering parties for multipart transactions backed by tokenized commodities on a peer-to-peer network, according to an example.

At 502, the method 500 may include assigning an identifier to a party. For example, the identifier may include a public key and, in some examples, a private key. The public key may include a unique identifier (such as being unique in the blockchain network 110) and may be publicly accessible. The private key may be held in secret by the party. In some examples, the public key may be associated with the private key such that the data signed using the private key may be verified to have been signed with the private key based on the public key, which may be publicly stored and available to the blockchain network 110 to verify data from the party that has been digitally signed using the private key.

At 504, the method 500 may include providing a blockchain interface, such as blockchain interface 114, to the party. In some examples, the blockchain interface 114 may include a blockchain wallet whose address is the public key. The blockchain wallet may include instructions that program a device to be used by the party for interacting with a peer-to-peer network of nodes, such as the nodes 112 of the blockchain network 110. For example, when a party submits verification of a sub-transaction for validation to the blockchain network 110, the party may do so via a blockchain transaction submitted via the blockchain wallet. Thus, examples of sub-transactions (or operations thereof) as described herein throughout may be submitted by the party via the party's blockchain wallet that may digitally sign the blockchain transaction with the party's private key.

At 506, the method 500 may include validating the multipart transaction between registered parties via the peer-to-peer network of nodes. Such validation may include verifying that individual sub-transactions (or operations thereof) of the multipart transaction have been digitally signed by a submitting party's private key.

At 508, the method 500 may include recording the validated multipart transactions as blocks in the distributed ledger. Such recordation may be implemented via DLT as described herein.

At 510, the method 500 may include providing access to the blocks on the distributed ledger to at least the registered parties. In some instances, the distributed ledger may serve as proof of ownership of a commodity that is used to back a multipart transaction at any given point in time of the multipart transaction.

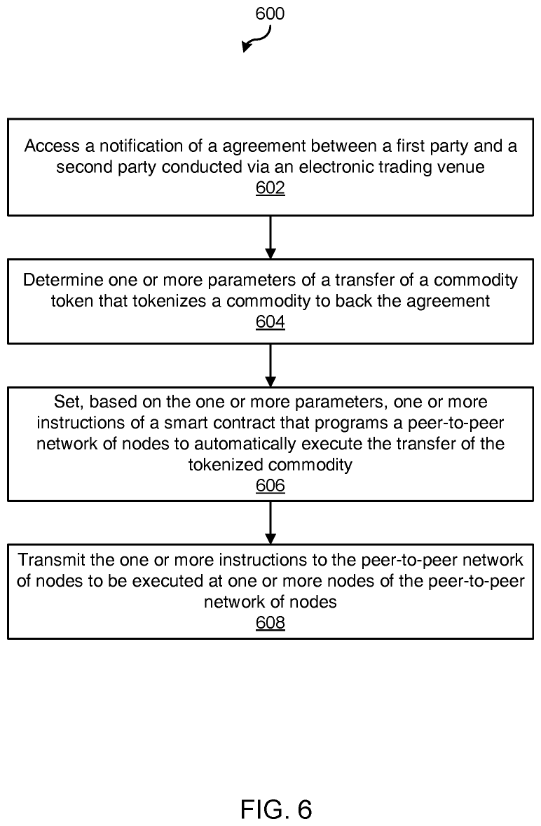

FIG. 6 illustrates a flow diagram of an example method 600 for facilitating multipart transactions backed by tokenized commodities on a blockchain, according to an example.

At 602, the method 600 may include accessing a notification of an agreement between a first party and a second party conducted via an electronic trading venue. For example, the method 600 may be implemented by a device programmed to receive notifications from a notification system that provides notifications of agreements such as trades made via the electronic trading venue. The agreement may relate to a first value to be provided from the second party to the first party and the first party is to provide the second party with an amount equal to the first value plus a second value. For example, the agreement may relate to a loan amount granted by the second party to the first party in exchange for repayment of the loan amount plus a profit amount that is in lieu of an interest rate. In other examples, the agreement may relate to a money market transaction. Other types of agreements in which a first value is provided in exchange for a later payment of a second value (usually higher than the first value).

At 604, the method 600 may include determining one or more parameters of a transfer of a tokenized commodity based on the first value and the second value. The tokenized commodity may represent a commodity to be sold by the second party to the first party through one or more brokers to back the agreement. Transfers of the tokenized commodity may represent ownership changes of the commodity and may be recorded on a distributed ledger, such as distributed ledger 101.

At 606, the method 600 may include setting, based on the one or more parameters, one or more instructions of a smart contract that programs a peer-to-peer network of nodes to automatically execute the transfer of the tokenized commodity between the first party, the second party, and the one or more brokers on a distributed ledger to provide proof of the transfer of the commodity between the first party, the second party, and the one or more brokers to back the agreement. In some examples, the peer-to-peer network of nodes may include a blockchain network, such as blockchain network 110. The distributed ledger in these examples may be stored by some or each of the nodes 112 of the blockchain network 110.

At 608, the method 600 may include transmitting the one or more instructions to the peer-to-peer network of nodes to be executed at one or more nodes of the peer-to-peer network of nodes. In various examples, the multipart transaction may include multiple sub-transactions, which of which may be individually validated and recorded on the distributed ledger.

For example, the multipart transaction may include a first sub-transaction between the second party and the one or more brokers to secure the commodity and transfer a commodity token, such as token 162, from the one or more brokers to the second party. In these examples, the smart contract may program one or more nodes of the network of nodes (such as nodes 112) to validate the first sub-transaction and record the first sub-transaction on the distributed ledger only upon confirmation of the first sub-transaction by each of the second party and the one or more brokers via the peer-to-peer network.

In some examples, the multipart transaction may further include a second sub-transaction between the first party and the second party to transfer the commodity token from the second party to the first party. In these examples, the smart contract may program one or more nodes of the network of nodes to validate the second sub-transaction and record the second sub-transaction on the distributed ledger only upon confirmation of the second sub-transaction by each of the first party and the second party via the peer-to-peer network. In some of these examples, the smart contract may further program one or more nodes of the network of nodes to transfer a promise-to-pay-token, such as token 164, from the first party to the second party as an atomic operation with the transfer of the commodity token from the second party to the first party.

In some examples, the multipart transaction may further include a third sub-transaction, mediated by the second party, between the first party and the one or more brokers to transfer the commodity token from the first party to the one or more brokers in exchange for the first value. In these examples, the smart contract programs one or more nodes of the network of nodes to validate the third sub-transaction and record the third sub-transaction on the distributed ledger only upon confirmation of the third sub-transaction by each of at least the first party and the one or more brokers party via the peer-to-peer network. In some of these examples, the smart contract may further program one or more nodes of the network of node to transfer a second money payment promise token 166 (also referred to as “token 166”) that tokenizes a promise to provide a loan amount from the sale of the commodity from the second party to the first party as an atomic operation with the transfer of the commodity token from the first party to the second party to mediate the commodity sale.

In some examples, the smart contract may further program one or more nodes of the network of nodes to cause a transfer of the first value from the second party to first party as an atomic operation with a transfer of proceeds of the commodity sale from the second party to the one or more brokers. For example, the when the second party has sold the commodity to the one or more brokers on behalf of the first party, the smart contract may validate the sale (based on blockchain transactions submitted by each of the second party and the one or more brokers) and cause the transfer of the proceeds to move from the one or more brokers to the second party. The smart contract may in turn cause the transfer of the first value to the first party.

In some examples, the one or more instructions further include instructions that programs a processor to access a quantity of the commodity available for exchange and generate a quantity of the commodity token based on the quantity of the commodity available for exchange.

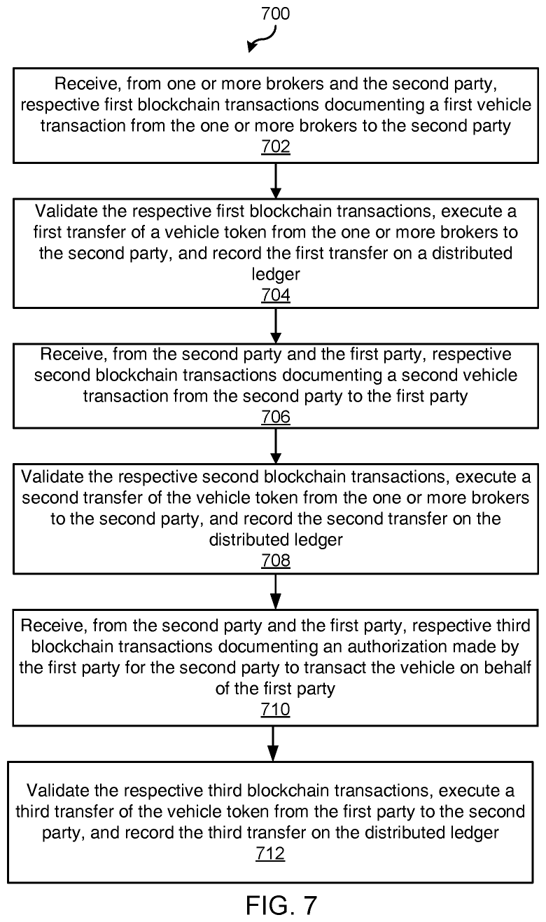

FIG. 7 illustrates a flow diagram of an example method 700 for processing sub-transactions of a multipart transaction backed by tokenized commodities in a blockchain network, according to an example. In some examples, the method 700 may be implemented in a smart contract 111 that programs a node 112 of the blockchain network 110. The multipart transaction may include various sub-transactions between various a first party, a second party, and one or more brokers of a commodity that is tokenized. For example, at 702, the method 700 may include receiving, from one or more brokers and the second party, respective first blockchain transactions that document a first commodity sale from the one or more brokers to the second party.

At 704, the method 700 may include validating the respective first blockchain transactions, executing a first transfer of a commodity token from the one or more brokers to the second party, and recording the first transfer on a distributed ledger.

At 706, the method 700 may include receiving, from the second party and the first party, respective second blockchain transactions that document a second commodity sale from the second party to the first party.

At 708, the method 700 may include validating the respective second blockchain transactions, executing a second transfer of the commodity token from the one or more brokers to the second party, and recording the second transfer on the distributed ledger.

At 710, the method 700 may include receiving, from the second party and the first party, respective third blockchain transactions that document an authorization made by the first party for the second party to sell the commodity on behalf of the first party.

At 712, the method 700 may include validating the respective third blockchain transactions, executing a third transfer of the commodity token from the first party to the second party, and recording the third transfer on the distributed ledger. In various examples, the recorded first transfer, the recorded second transfer, and the recorded third transfer on the distributed ledger may provide immutable proof of ownership of the commodity during the multipart transaction.

It should be understood that the methods 500-700 illustrated in FIGS. 5-7 may each include additional operations and that some of the operations described therein may be removed and/or modified without departing from the scopes of the methods 500-700. The description of the methods 500-700 may be made with reference to the features depicted other figures for purposes of illustration. Some or all of the operations set forth in each of the methods 500-700 may be performed by one or more of the components illustrated in FIG. 1, 3, or 4. As such, some or all of the operations set forth in each of the methods 500-700 may be included as circuitry, utilities, programs, or subprograms, in any desired computer accessible medium. In addition, each of the methods 500-700 may be embodied by computer programs, which may exist in a variety of forms. For example, some operations of each of the methods 500-700 may exist as machine-readable instructions, including source code, object code, executable code or other formats.

For simplicity and illustrative purposes, the disclosure included descriptions that may refer to examples. In the description, numerous specific details have been set forth in order to provide a thorough understanding of the present disclosure. It will be readily apparent however, that the disclosure may be practiced without limitation to these specific details. In other instances, some methods and structures have not been described in detail so as not to unnecessarily obscure the present disclosure.

Throughout the disclosure, the terms “a” and “an” may be intended to denote at least one of a particular element. As used herein, the term “includes” means includes but not limited to, the term “including” means including but not limited to. The term “based on” means based at least in part on.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure. What has been described and illustrated herein is an example of the disclosure along with some of its variations. The terms, descriptions and figures used herein are set forth by way of illustration only and are not meant as limitations. As such, the disclosure is intended to be defined by the following claims—and their equivalents—in which all terms are meant in their broadest reasonable sense unless otherwise indicated.

What is claimed is:

1. A computer-readable medium that stores instructions to facilitate a multipart transaction in a peer-to-peer network, the instructions, when executed by a processor, program the processor to:
access a notification of an agreement between a first party and a second party conducted via an electronic trading venue, wherein the agreement relates to a first value to be provided from the second party to the first party and the first party is to provide the second party with an amount equal to the first value plus a second value;
determine, based on the first value and the second value, one or more parameters of a transfer of a commodity token that tokenizes a commodity to back the agreement, wherein the transfer of the commodity token represents a change in ownership of the commodity and is recorded on a distributed ledger;
set, based on the one or more parameters, one or more instructions of a smart contract that programs a peer-to-peer network of nodes to automatically execute the transfer of the tokenized commodity between the first party, the second party, and the one or more brokers on a distributed ledger to provide proof of the transfer of the commodity between the first party, the second party, and the one or more brokers to back the agreement; and
transmit the one or more instructions to the peer-to-peer network of nodes to be executed at one or more nodes of the peer-to-peer network of nodes.

2. The computer-readable medium of claim 1, wherein the peer-to-peer network of nodes comprises a blockchain network that implements distributed ledger technology, wherein some or each of the network of nodes stores a local copy of the distributed ledger on which is stored an immutable record of the multipart transaction.

3. The computer-readable medium of claim 1, wherein the multipart transaction comprises a first sub-transaction between the second party and the one or more brokers to secure the commodity and transfer a commodity token from the one or more brokers to the second party, and wherein the smart contract programs one or more nodes of the network of nodes to validate the first sub-transaction and record the first sub-transaction on the distributed ledger only upon confirmation of the first sub-transaction by each of the second party and the one or more brokers via the peer-to-peer network.

4. The computer-readable medium of claim 3, wherein the multipart transaction comprises a second sub-transaction between the first party and the second party to transfer the commodity token from the second party to the first party, wherein the smart contract programs one or more nodes of the network of nodes to validate the second sub-transaction and record the second sub-transaction on the distributed ledger only upon confirmation of the second sub-transaction by each of the first party and the second party via the peer-to-peer network.

5. The computer-readable medium of claim 4, wherein the smart contract further programs one or more nodes of the network of nodes to transfer a promise-to-pay-token from the first party to the second party as an atomic operation with the transfer of the commodity token from the second party to the first party.

6. The computer-readable medium of claim 4, wherein the multipart transaction comprises a third sub-transaction, mediated by the second party, between the first party and the one or more brokers to transfer the commodity token from the first party to the one or more brokers in exchange for the first value, wherein the smart contract programs one or more nodes of the network of nodes to validate the third sub-transaction and record the third sub-transaction on the distributed ledger only upon confirmation of the third sub-transaction by each of at least the first party and the one or more brokers party via the peer-to-peer network.

7. The computer-readable medium of claim 6, wherein the smart contract further programs one or more nodes of the network of nodes to transfer a promise to provide a loan amount from a sale of the commodity from the second party to the first party as an atomic operation with the transfer of the commodity token from the first party to the second party to mediate the sale of the commodity.

8. The computer-readable medium of claim 1, wherein the smart contract further programs one or more nodes of the network of nodes to cause a transfer of the first value from the second party to first party as an atomic operation with a transfer of proceeds of the sale of the commodity from the second party to the one or more brokers.

9. The computer-readable medium of claim 1, wherein the one or more instructions further include instructions to:
access a quantity of the commodity available for exchange; and
generate a quantity of the commodity token based on the quantity of the commodity available for exchange.

10. The computer-readable medium of claim 1, wherein the multipart transaction comprises a Murabaha transaction.

11. A computer-readable medium that stores instructions, including a smart contract, to facilitate a multipart transaction in a peer-to-peer network, the instructions, when executed by a processor, program the processor to:
access a notification of an agreement between a first party and a second party, wherein the agreement relates to a first value to be provided from the second party to the first party and the first party is to provide the second party with an amount equal to the first value plus a second value;
determine, based on the first value and the second value, one or more parameters of a transfer of a commodity token that tokenizes a commodity to back the agreement, wherein the transfer of the commodity token represents a change in ownership of the commodity and is recorded on a distributed ledger;
set, based on the one or more parameters, one or more instructions of a smart contract that programs a peer-to-peer network of nodes to automatically execute the transfer of the tokenized commodity between the first party, the second party, and the one or more brokers on a distributed ledger to provide proof of the transfer of the commodity between the first party, the second party, and the one or more brokers to back the agreement; and
transmit the one or more instructions to the peer-to-peer network of nodes to be executed at one or more nodes of the peer-to-peer network of nodes.

12. The system of claim 11, wherein the peer-to-peer network of nodes comprises a blockchain network that implements distributed ledger technology, wherein the system further comprises:
a node from among the network of nodes, wherein the node stores a local copy of the distributed ledger on which is stored an immutable record of the multipart transaction.

13. The system of claim 12, wherein the multipart transaction comprises a first sub-transaction between the second party and the one or more brokers to secure the commodity and transfer a commodity token from the one or more brokers to the second party, and wherein the smart contract programs the node to:
validate the first sub-transaction and record the first sub-transaction on the distributed ledger only upon confirmation of the first sub-transaction by each of the second party and the one or more brokers via the peer-to-peer network.

14. The system of claim 13, wherein the multipart transaction comprises a second sub-transaction between the first party and the second party to transfer the commodity token from the second party to the first party, wherein the smart contract further programs the node to:
validate the second sub-transaction and record the second sub-transaction on the distributed ledger only upon confirmation of the second sub-transaction by each of the first party and the second party via the peer-to-peer network.

15. The system of claim 14, wherein the smart contract further programs the node to:
transfer a promise-to-pay-token from the first party to the second party as an atomic operation with the transfer of the commodity token from the second party to the first party.

16. The system of claim 14, wherein the multipart transaction comprises a third sub-transaction, mediated by the second party, between the first party and the one or more brokers to transfer the commodity token from the first party to the one or more brokers in exchange for the first value, wherein the smart contract further programs the node to:
validate the third sub-transaction and record the third sub-transaction on the distributed ledger only upon confirmation of the third sub-transaction by each of at least the first party and the one or more brokers party via the peer-to-peer network.

17. The system of claim 16, wherein the smart contract further programs the node to:
transfer a promise to provide a loan amount from a sale of the commodity from the second party to the first party as an atomic operation with the transfer of the commodity token from the first party to the second party to mediate the sale of the commodity.

18. A computer-readable medium that stores instructions, including a smart contract that encodes terms of an agreement, backed by a tokenized vehicle, between a first party and a second party, to facilitate a multipart transaction for the agreement in a peer-to-peer network, the instructions, when executed by a processor, program the processor to:
receive, from one or more brokers and the second party, respective first blockchain transactions that document a first vehicle transaction from the one or more brokers to the second party;
validate the respective first blockchain transactions, execute a first transfer of a vehicle token from the one or more brokers to the second party, and record the first transfer on a distributed ledger;
receive, from the second party and the first party, respective second blockchain transactions that document a second vehicle transaction from the second party to the first party;
validate the respective second blockchain transactions, execute a second transfer of the vehicle token from the one or more brokers to the second party, and record the second transfer on the distributed ledger;
receive, from the second party and the first party, respective third blockchain transactions that document an authorization made by the first party for the second party to transact the vehicle on behalf of the first party; and
validate the respective third blockchain transactions, execute a third transfer of the vehicle token from the first party to the second party, and record the third transfer on the distributed ledger,
wherein the recorded first transfer, the recorded second transfer, and the recorded third transfer on the distributed ledger provides immutable proof of ownership of the vehicle during the multipart transaction.

19. The computer-readable medium of claim 18, wherein the instructions further program, when executed by the processor, further program the processor to:
in response to validation of the respective second blockchain transactions, execute a transfer of a promise-to-pay token from the first party to the second party in an atomic operation with the second transfer.

20. The computer-readable medium of claim 18, wherein the instructions further program, when executed by the processor, further program the processor to:
in response to validation of the respective second blockchain transactions, execute a transfer of a promise-to-pay token from the first party to the second party in an atomic operation with the second transfer.
